(19) United States
(12) Patent Application Publication
(10) Pub. No.: US 2025/0146104 A1
(43) Pub. Date: May 8, 2025

(54) RECOVERING RARE EARTH ELEMENTS

(71) Applicant: AUSTRALIAN NATIONAL UNIVERSITY, Australian Capital Territory (AU)

(72) Inventor: Andrew BERRY, Australian Capital Territory (AU)

(73) Assignee: AUSTRALIAN NATIONAL UNIVERSITY, Australian Capital Territory (AU)

(21) Appl. No.: 18/730,625

(22) PCT Filed: Jan. 20, 2023
(86) PCT No.: PCT/AU2023/050032

§ 371 Date: Jul. 19, 2024

(30) Foreign Application Priority Data
Jan. 20, 2022 (AU) 2022900105

(51) Int. Cl. C22B 59/00; C22B 1/02; C22B 3/06; C22B 3/22

(52) U.S. Cl. CPC C22B 59/00; C22B 1/02; C22B 3/06; C22B 3/22

(57) ABSTRACT

Disclosed herein is a process for recovering one or more rare earth elements from a phosphate ore that comprises the one or more rare earth elements. The process can comprise mixing the phosphate ore comprising the one or more rare earth elements with a carbonate-based flux. The process can also comprise subjecting the mixture to conditions such that the one or more rare earth elements are released from the phosphate ore and form one or more rare earth element compounds.

### TECHNICAL FIELD

This disclosure relates to a process for recovering rare earth elements from, in particular, phosphate ores, such as monazite, xenotime and apatite. The process uses a molten carbonate-based flux to dissolve the phosphate ore comprising the rare earth elements followed by cooling the molten mixture to allow different rare earth element compounds to form. The process is also suitable for recovering elements from oxide and silicate minerals, such as niobium and tantalum from oxides, rare earth elements from eudialyite and zirconium from zircon.

### BACKGROUND ART

Rare earth elements are considered critical metals as they are essential in the production of many modern devices, for example mobile phones, magnets and batteries. Rare earth elements also find use as catalysts, in ceramic and glass production, in lasers, as metal alloys, etc.

Over the past decade, demand for rare earth elements has rapidly increased. The supply of rare earth elements is dominated by China, which accounted for nearly 60% of the rare earth oxide equivalent produced globally in 2020. Reliance on one country for the majority of the world's supply of a resource can put the supply at risk, for example, due to geopolitical issues such as in 2010 when China restricted exports of rare earth elements.

Only three rare earth element bearing minerals are currently considered to be economical to mine. These are: monazite [(Ce,La,Nd,Th)PO₄], bastnasite [(Ce,La,Y)CO₃F] and xenotime [YPO₄], all of which contain many other rare earth elements substituting for Y and Ce. Two of these three minerals are phosphates. Apatite [Ca₃(PO₄)₅(F,Cl,OH)] is another phosphate that can also be mined, but contains a much lower concentration of rare earth elements (i.e. there are no rare earth elements in the formula). Phosphorites, a sedimentary rock rich in apatite is another potential source of rare earth elements. The traditional extraction route for the phosphate-based minerals comprising rare earth elements is similar.

The mineral-bearing ore first undergoes beneficiation to separate and concentrate the mineral comprising the rare earth elements. Beneficiation can include processes such as froth flotation, electrostatic force separation, and gravity or magnetic separation. The separated mineral comprising the rare earth elements is next pre-treated by roasting or digesting the ore in the presence of an acid or alkali (as a solution or a solid) at elevated temperatures, ranging from 200-600° C. A solution comprising rare earth elements is formed by a combination of processes which may include water leaching, treatment with sodium hydroxide and/or a second acid leaching stage. Contaminating elements are removed from this solution by a variety of methods followed by precipitation of the REE as either oxides or carbonates.

Critical to the future of the global rare earth elements industry is finding new ways of mining and extracting rare earth elements from deposits. New processes also need to take into consideration concerns regarding thorium and uranium waste, as these radioactive elements are often associated with rare earth element-hosting minerals.

It is to be understood that a reference to prior art herein does not constitute an admission that the prior art forms a part of the common general knowledge in the art, in Australia or any other country.

### SUMMARY

Disclosed herein in a first aspect is a process for recovering one or more rare earth elements from a phosphate ore that comprises the one or more rare earth elements. Surprisingly and advantageously, the process can exploit the mechanism by which phosphate ores comprising rare earth elements were naturally formed from carbonate melts, by using a carbonate melt to dissolve the phosphate ore.

In nature, many phosphate ores comprising rare earth elements crystallised from carbonate melts or carbonate magmas. During formation, carbonate melts may have become enriched with rare earth elements. As the carbonate melt cools, a variety of minerals can be formed. These minerals can include carbonates, phosphates (for example, monazite, apatite and xenotime) and oxides of other metals (for example, pyrochlore).

Rocks derived from carbonate magmas are known as carbonatites. As well as containing relatively high concentrations of rare earth elements (>500 ppm) compared with other igneous rocks, carbonatites also contain variable amounts of thorium and uranium. Although carbonate magmas are considerably rarer than silicate magmas, there are still more than 500 known carbonatites across the globe.

Since naturally occurring phosphate ore comprising rare earth elements can form (crystallise) from a carbonate melt, by subjecting phosphate ore (e.g. monazite, xenotime, apatite, phosphorite) to a molten carbonate, the phosphate ore can be broken down (or re-dissolved), liberating the rare earth elements from the mineral structure. During cooling, the rare earth elements may partition into the carbonate phase.

Naturally occurring phosphate ore comprising rare earth elements can also be in the form of sedimentary rocks, e.g. phosphorite. Although formed from a different natural mechanism to igneous phosphate ores (i.e. through deposition and compaction of sediments as opposed to volcanic activity), sedimentary phosphate ores may still be broken down (or dissolved) by a carbonate melt.

Thus, the process as disclosed herein can comprise mixing the phosphate ore comprising the one or more rare earth elements with a carbonate-based flux. Both the carbonate-based flux and the phosphate ore may typically be in the form of a finely crushed solid.

The process can also comprise subjecting the mixture to conditions such that the one or more rare earth elements are released from the phosphate ore and, on cooling, form one or more (new) rare earth element compounds. The conditions can comprise a temperature that causes the carbonate-based flux to melt. The one or more rare earth element compounds formed on cooling are different to the one or more rare earth element minerals present in the phosphate ore. The newly formed rare earth element compounds may be soluble in acid. Without wishing to be bound by theory, the inventor postulates the new rare earth element compounds are rare earth element carbonate and/or oxide compounds.

The process can further comprise washing a resultant solid with water to substantially dissolve residual carbonate-based flux therefrom.

A primary advantage of the process disclosed herein is that it does not rely on harsh chemical treatments to break down the structure of the phosphate ore, for example, concentrated acids or bases. Instead, the natural process by which the phosphate ore was formed may, in effect, be reversed by adding the phosphate ore to a carbonate melt.

In some embodiments, the mixture may be held at the temperature that causes the carbonate-based flux to melt for a predetermined time. The phosphate ore comprising the one or more rare earth elements may substantially dissolve in the molten carbonate-based flux. As the phosphate ore dissolves, the one or more rare earth elements may be released therefrom.

In some embodiments, the conditions the mixture is subjected to may further comprise allowing the molten mixture to solidify, after the predetermined time has elapsed. As the molten mixture solidifies, the one or more new rare earth element (likely carbonate and/or oxide) compounds may thereby form a solid. The rate of solidification is typically fast enough to ensure the rare earth elements are associated with the new (likely carbonate and/or oxide) phase rather than the phosphate phase. On a small scale, allowing the molten mixture to solidify, for example, by no longer subjecting the mixture to heating, may allow for a fast-enough cooling rate such that the rare earth elements form carbonate and/or oxide minerals. However, on a larger scale (e.g. where larger masses of phosphate ore and carbonate-based flux are employed), the larger thermal mass of a larger mixture can result in a slower cooling rate. To maximise the recovery of the rare earth elements, the solidification may thus also comprise causing the molten mixture to solidify quickly. For example, the mixture may be rapidly cooled such as by using air or water.

In some embodiments, the elevated temperature may be in the range of about 500° C. to about 650° C. The elevated temperature is typically around 50° C. higher than the melting point of the carbonate-based flux. In this regard, the melting point of the carbonate-based flux is dependent on the composition of the flux. For example, in other embodiments where the carbonate-based flux has a higher melting point, the elevated temperature may be as high as about 800° C. In other embodiments, the carbonate-based flux may be heated to greater than 50° C. above its melting point. For example, to facilitate reaction between the flux and mineral.

In some embodiments, the predetermined time may be about 2 hours. The predetermined time should be sufficient to ensure that the carbonate-based flux melts and the phosphate ore comprising the one or more rare earth elements substantially dissolves. However, the predetermined time can be controlled to not be too long, or the melt may cause the carbonate-based flux to partially decarbonate, thereby reducing the recovery of the rare earth elements. Decarbonation of the flux can also reduce the amount of flux that can be recovered and recycled, which may impact the economic viability of the process.

In some embodiments, the process may be conducted at ambient pressure. However, the pressure can be dependent on the type of carbonate-based flux selected. For example, when sodium and/or potassium carbonate-based fluxes are used, the process may be conducted at ambient pressure. On the other hand, if calcium and/or magnesium carbonate based-fluxes are used, the conditions the mixture is subjected to may comprise elevated pressures. This is because elevated pressures can be required to minimise the extent to which decarbonation occurs (e.g. with calcium and/or magnesium carbonate based-fluxes). The use of sodium and/or potassium carbonate-based fluxes are therefore preferred, as the process can be performed at ambient pressure. Furthermore, the elevated pressures required to minimise the decarbonation of calcium and/or magnesium carbonate-based fluxes tend to be uneconomically high.

The phosphate ores comprising the one or more rare earth elements may also comprise uranium and/or thorium, which are both radioactive. The process disclosed herein can be advantageously performed over prior art processes in that, by altering the conditions to which the carbonate-based flux and phosphate ore are subjected, the extraction of uranium and/or thorium may be reduced.

In some embodiments, the resultant one or more rare earth element compounds may be separated from a residue of the solid. For example, the separation of the new rare earth element compounds from the residue of the solid may comprise crushing the solid comprising the one or more new rare earth element compounds, thereby producing a crushed solid. The solid may be crushed to increase the surface area to volume ratio, which can increase the rate at which subsequent stages of the process occur. Typically, the solid is crushed into a fine powder. In this regard, washing the resultant solid with water can comprise washing the fine powder with water so as to substantially dissolve residual carbonate-based flux values therefrom.

In some embodiments, the separation of the new rare earth element compounds from the residue of the solid may further comprise washing the crushed solid with water to substantially dissolve residual carbonate-based flux therefrom. In this regard, the wash water comprising the dissolved residual carbonate-based flux may be separated from a flux-depleted solid. For example, this separation may be achieved using filtration. The separated wash water may be further treated to recover the carbonate-based flux as a solid substantially free of liquid. For example, this further treatment may comprise evaporation.

In some embodiments, the solid carbonate-based flux substantially free of liquid may be recycled to comprise at least a portion of the carbonate-based flux. It will thus be appreciated that another advantage of the process as disclosed herein can be that the main reagent (i.e. the carbonate-based flux) can be recovered and recycled, reducing the quantity of fresh flux required. This may increase the economic viability of the process.

In some embodiments, the separation of the new rare earth element compounds from the residue of the mixture may additionally comprise washing the resultant flux-depleted crushed solid with acid to substantially dissolve the one or more new rare earth element compounds therefrom. A solution comprising the one or more rare earth elements and the residue may thereby be produced. For example, the wash acid may have a concentration of about 1 M. It will be appreciated that the concentration of the wash acid will depend on the type of acid used. For example, for a strong acid (e.g. mineral acid), a concentration of 1 M may be sufficient.

In some embodiments, the wash acid may comprise a mineral acid. For example, the mineral acid may comprise one of nitric acid, hydrochloric acid or sulfuric acid.

In some embodiments, the separation of the new rare earth element compounds from the residue of the solid may further comprise separating the solution comprising the one or more rare earth elements from the residue. For example, said separation may be by filtration. Optionally, the solution comprising the one or more rare earth elements may be further treated to remove impurity elements (such as U, Th, Ra and/or Fe) and produce one or more rare earth element products.

In some embodiments, the mixture comprising the phosphate ore comprising the one or more rare earth elements and the molten carbonate-based flux may comprise a greater proportion by mass of the carbonate-based flux than the phosphate ore comprising the one or more rare earth elements. For example, the ratio of the carbonate-based flux to the phosphate ore by mass may be at least 2:1. The amount of carbonate-based flux can be sufficient to allow the phosphate ore to dissolve nearly completely, thereby maximising the recovery of the rare earth elements.

In some embodiments, the phosphate ore may comprise at least one of the minerals monazite, xenotime or apatite. It will be appreciated that, when the mineral comprising the one or more rare earth element is a phosphate mineral, the process disclosed herein becomes applicable. It will further be appreciated that the process can be used for the recovery of rare earth elements from minerals other than monazite, xenotime and apatite. For example, the process could be used for the recovery of rare earth elements from sedimentary rocks, such as phosphorite.

In some embodiments the carbonate-based flux may comprise sodium carbonate and potassium carbonate. The sodium and potassium carbonate-based flux may be synthetic. It will be appreciated that, in nature, the majority of known carbonatite deposits (i.e. natural carbonates) are comprised primarily of calcium and magnesium carbonates. However, when heated at atmospheric pressure, they decarbonate (break down to release CO₂) rather than melt. The presence of calcium and magnesium carbonates in nature is because they were formed and cooled at a depth within the Earth and were thus under pressure. On the other hand, carbonates comprised primarily of sodium and potassium melt prior to decarbonation at atmospheric pressure. Sodium and potassium carbonate melts also exhibit lower melting points compared with magnesium/calcium carbonate melts. As an example, currently one volcano is erupting a sodium-potassium (plus some calcium) carbonate magma (Oldoinyo Lengai in Tanzania) which is stable at atmospheric pressure. The Oldoinyo Lengai mixture further comprises other elements (including strontium, barium, silicon, iron) which combine to provide a carbonate melt with a melting point of less than about 600° C.

In some embodiments, the sodium and potassium carbonate flux may further comprise chloride. The chloride may be present in the form of at least one of sodium chloride or potassium chloride. The addition of chloride can lower the melting point of the carbonate-based flux. As the process is typically performed at a temperature greater than the melting point of the carbonate-based flux (i.e. so it is molten), by lowering the melting point of the flux, the overall energy requirements are likewise lowered.

In some embodiments, the carbonate-based flux may comprise about 30% sodium carbonate, about 50% potassium carbonate and about 20% potassium chloride. That is, a eutectic mixture of sodium carbonate, potassium carbonate and potassium chloride. This carbonate-based flux may be synthetic.

In other embodiments, the carbonate-based flux may instead comprise sodium carbonate and sodium chloride. This carbonate-based flux may be synthetic. It will be appreciated that natural carbonate melts may comprise significant amounts of potassium carbonate. Whilst potassium carbonate is a relatively cheap reagent, it may be significantly more expensive than either sodium carbonate or sodium chloride. Thus, a flux comprising sodium carbonate and sodium chloride may offer significant economic advantages, compared to fluxes which comprise potassium-based reagents.

In some of these other embodiments, the carbonate-based flux may comprise about 60% sodium carbonate and about 40% sodium chloride by weight. That is, a eutectic mixture of sodium carbonate and sodium chloride.

In this regard, it will be appreciated that different compositions of sodium carbonate and/or potassium carbonate and/or sodium chloride and/or potassium chloride could be used as the carbonate-based flux in the process disclosed herein, albeit with different melting points. In particular, the flux may comprise any combination of sodium carbonate and/or potassium carbonate and/or sodium chloride and/or potassium chloride.

In some embodiments, phosphate in the phosphate ore may be converted to sodium phosphate (e.g. as trisodium phosphate) and/or potassium phosphate as the one or more rare earth elements are released therefrom. In particular, the phosphate in the phosphate ore may dissolve into the melted carbonate-based flux. As the resultant melt cools, the phosphate may form sodium phosphate and/or potassium phosphate. For example, when the flux comprises sodium, the phosphate may be converted to sodium phosphate. As another example, when the flux comprises potassium, the phosphate may be converted to potassium phosphate. As yet a further example, when the flux comprises both sodium and potassium, the phosphate may be converted to both sodium phosphate and potassium phosphate. The sodium phosphate and/or potassium phosphate so-formed may dissolve as the residue of the solid is washed with water to substantially dissolve residual carbonate-flux therefrom. In this regard, the wash water comprising the dissolved residual carbonate-based flux may further comprise sodium phosphate and/or potassium phosphate.

In some of these embodiments, the process may further comprise separating the sodium phosphate and/or potassium phosphate from the carbonate-based flux. For example, the sodium phosphate and/or potassium phosphate may be separated by fractional crystallisation during evaporation of the solution. The recovered sodium phosphate and/or potassium phosphate may represent a valuable by-product of the process.

In some embodiments, the carbonate-based flux may also comprise minor additions of other elements. For example, a sodium and potassium carbonate (and/or chloride) flux may comprise minor additions of lithium, or calcium, or strontium, or barium in the form of lithium or calcium or strontium or barium chloride and/or lithium or calcium or strontium or barium carbonate. As another example, a sodium carbonate and sodium chloride flux may comprise minor additions of lithium or calcium or strontium or barium chloride and/or lithium or calcium or strontium or barium carbonate. The minor additions of other elements can be selected to lower the melting point of the flux. With further additions of more (impurity) elements, the melting point may be further lowered. However, the addition of more (impurity) elements can increase the complexity of creating and recovering the flux. It can also increase the cost, as more raw materials can be required. It will be appreciated that it is preferable to select a flux with as few elements as possible to minimise the cost and complexity of the process.

In some embodiments, the ore comprising the one or more rare earth elements may be pre-treated. For example, the bulk ore comprising the one or more rare earth elements may be pre-treated by using flotation or gravity separation. The pre-treated ore may then be mixed with the carbonate-based flux.

An application of the process disclosed herein may be for extracting rare earth elements from monazite “waste” produced as a by-product of titanium production from beach sands. Monazite is present in many beach sands. When titanium is mined from beach sands, the monazite is removed and discarded. Currently, this represents a “waste” that must be disposed of. However, with the presently disclosed process, the monazite may be processed to recover the rare earth elements therein. Alternatively or additionally, beach sands may be mined directly for monazite.

Yet another application of the process disclosed herein may be for processing residual mine tailings. When phosphate ore minerals are intermingled with other minerals, the rock needs to be crushed so the phosphate ore minerals are accessible. The phosphate ore minerals can optionally be separated and concentrated, for example by froth flotation. The crushing stage requires a large consumption of energy, with crushing representing about 56% of the mining sector's total energy use. After the ore has already been crushed as part of another processing operation, for example, for copper or gold recovery, the residual tailings may be rich in rare earth elements. The cost of crushing has already been incurred, allowing more value to be extracted from the waste if the residual tailings are further processed to concentrate the phosphate for the present process.

Also disclosed herein in a second aspect is a process for recovering a certain metal or certain metals from an oxide ore that comprises the certain metal(s). The process of the second aspect may be suitable for treating certain oxides such as, but not limited to, pyrochlore, columbite, fersmite or tantalite, i.e. where the natural oxide may have formed from a carbonatite melt. However, the process of the second aspect may not be suitable for other metal oxides, i.e. where the oxide may not be formed from or may not be soluble in a carbonatite melt.

The process of the second aspect can comprise mixing the oxide ore comprising the certain metal(s) with a carbonate-based flux.

The process of the second aspect can further comprise subjecting the mixture to conditions such that the certain metal(s) are released from the oxide ore and form one or more carbonate or oxide minerals comprising the certain metal(s).

In some embodiments, the process of the second aspect may further comprise separating the one or more metal carbonate or oxide minerals from a residue of the mixture. For example, the oxide ore mineral may comprise at least one of the minerals pyrochlore, columbite, fersmite or tantalite, and the certain metal(s) may comprise at least one of the metals niobium or tantalum. However, it should be appreciated that the process of the second aspect is not limited to minerals that comprise niobium or tantalum.

In some embodiments, the process of the second aspect may otherwise be the same as the process of the first aspect.

In some embodiments, the carbonate-based flux may further comprise one or more of: chloride, silica, phosphate. It is thought that the addition of silica and/or phosphate may aid in the dissolution of oxide ores in carbonate-based fluxes.

Also disclosed herein in a third aspect is a process for recovering a certain metal or certain metals from a silicate ore that comprises the certain metal(s). The process of the third aspect can be suitable for treating certain silicates such as zircon (to extract zirconium), eudialyte (to extract the rare earth elements) and spodumene (to extract lithium).

The process of the third aspect can comprise mixing the silicate ore comprising the certain metal(s) with a carbonate-based flux.

The process of the third aspect can further comprise subjecting the mixture to conditions such that the certain metal(s) are released from the silicate ore and form one or more carbonate or oxide minerals comprising the certain metal(s).

In some embodiments, the process of the third aspect may further comprise separating the one or more metal carbonate or oxide minerals from a residue of the mixture.

In some embodiments of the process of the third aspect, the silicate ore mineral may comprise at least one of the minerals zircon, eudialyte and spodumene, and the certain metal(s) may comprise at least one of zirconium, at least one rare earth element, or lithium.

In some embodiments, the process of the third aspect may otherwise be the same as the process of the first aspect.

In some embodiments, the carbonate-based flux may further comprise one or more of: chloride, silica, phosphate. Typically, the carbonate-based flux further comprises at least chloride.

### BRIEF DESCRIPTION OF THE DRAWINGS

Embodiments will now be described by way of example only, with reference to the accompanying drawings in which:

FIG. 1 is a schematic block flow diagram of a process for recovering one or more rare earth elements from a phosphate ore comprising the one or more rare earth elements, as disclosed herein; and FIG. 1A is a schematic block flow diagram of an embodiment of a flux and phosphate recovery stage of the process of FIG. 1.

FIG. 2 is a plot showing the concentration of rare earth elements (in parts per million) in the synthetic monazite, natural monazite and natural xenotime samples used in the Examples herein.

FIG. 3 is a back-scattered electron image of a synthetic monazite sample, containing a mixture of monazite and CeO₂. The black parts of the image correspond to empty space (porosity) in the sample.

FIGS. 4 and 5 are plots showing the recovery of rare earth elements (% yield) from synthetic monazite samples as function of the ratio of monazite to carbonate-based flux used for two different carbonate-based flux compositions (a eutectic Na₂CO₃—K₂CO₃—KCl composition, FIG. 4, and a synthetic analogue of the carbonate melt from Oldoinyo Lengai, FIG. 5, see Table 2).

FIG. 6 is an XRD pattern of residue resulting from reacting synthetic monazite with a carbonate-based flux and recovering the rare earth elements using the process as disclosed herein. The peaks labelled correspond to CeO₂.

FIG. 7 is a plot showing the recovery of rare earth elements from synthetic monazite using the eutectic Na₂CO₃—K₂CO₃—KCl carbonate-based flux as a function of time.

FIG. 8 is a plot showing the recovery of rare earth elements, U and Th from natural monazite as a function of the ratio of monazite to the eutectic Na₂CO₃—K₂CO₃—KCl carbonate-based flux. Data is not shown for elements with low concentration (<˜1000 ppm) in natural monazite.

FIGS. 9 and 10 are plots showing the recovery of rare earth elements, U and Th from xenotime samples as function of the ratio of xenotime to carbonate-based flux used for two different carbonate-based flux compositions (a eutectic Na₂CO₃—K₂CO₃—KCl composition, FIG. 9 and a synthetic analogue of the carbonate melt from Oldoinyo Lengai, FIG. 10, see Table 2). Data is not shown for elements with low concentration (<˜1000 ppm) in xenotime. Low yields of Gd (relative to Sm and Tb) are believed to be an analytical artefact.

FIG. 11 is an SEM image of a sample obtained by mixing zircon with the eutectic Na₂CO₃—NaCl carbonate-based flux and subjecting the mixture to a thermal treatment stage.

FIG. 12 is an SEM image of a residue obtained by leaching the sample of FIG. 11 with water followed by calcination at 800° C.

### DETAILED DESCRIPTION

In the following detailed description, reference is made to accompanying drawings, which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Disclosed herein is a process for recovering one or more rare earth elements from a phosphate ore comprising the one or more rare earth elements. Specific embodiments of the process only require moderately elevated temperatures, readily available reagents, and do not require the use of concentrated acids or bases. More specifically, phosphate ores comprising rare earth elements are dissolved in a carbonate-based flux at a temperature above the melting point of the carbonate-based flux. The disclosed process effectively ‘reverse engineers’ the natural process by which some phosphate ores were formed. Further, by transforming the rare earth elements into different (most likely, carbonate and/or oxide) minerals, the rare earth elements are easier to separate from residue material because they become soluble in dilute acid.

The applicability of the process herein disclosed for recovering one or more rare earth elements from a phosphate ore comprising the one or more rare earth elements is also illustrated by way of Examples below. The Examples show the recovery of rare earth elements from phosphate ores that were mixed with different ratios of different carbonate-based fluxes and were held at elevated temperatures for different time periods. The inventor notes that the monazite used in Examples 3 and 4 was impure (as it was composed of a mixture of monazite and cerium (IV) oxide). Such a material obscures to some extent the elegance, simplicity and effectiveness of the process, which would otherwise be revealed through the use of a more pure starting material, such as naturally occurring monazite. The effectiveness of the process in recovering rare earth elements from naturally occurring monazite is shown by way of Example 5.

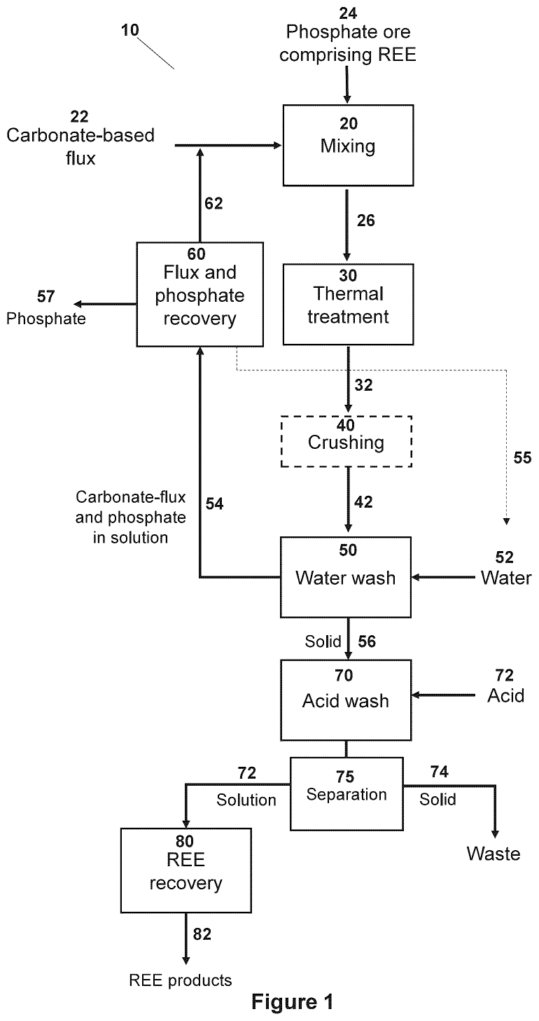

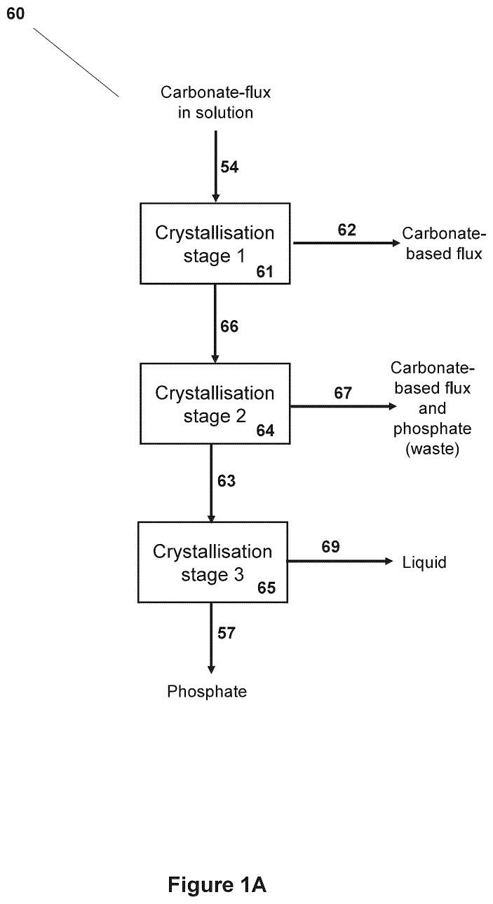

Referring now to FIG. 1, a concept flow diagram, set out in simple block diagram form, illustrates a process 10 for recovering one or more rare earth elements from a phosphate ore comprising the one or more rare earth elements. The feed to process 10 is a phosphate ore 24 comprising the one or more rare earth elements.

Prior to subjecting the ore to the process 10, a bulk ore containing the phosphate minerals comprising rare earth elements and other minerals may be passed through an optional beneficiation stage. In the beneficiation stage, the phosphate minerals comprising rare earth elements are pre-treated. The bulk ore is subject to treatment whereby phosphate minerals are separated from other minerals and gangue material. The treatment includes a series of crushing and separation stages, such as flotation or gravity separation. It will be appreciated that the pre-treatment can be tailored based on the properties of the bulk ore and phosphate mineral(s). Known pre-treatment methods can be employed. The pre-treated phosphate ore is then used as the feed to the process 10. Alternatively, the bulk ore can be fed to the process 10 directly.

The process 10 comprises a first mixing stage 20, wherein a carbonate-based flux 22 and phosphate ore 24 comprising rare earth elements are mixed in a platinum crucible. Further examples for industrial scale-up are set forth below.

The carbonate-based flux 22 and phosphate ore 24 are both typically in the form of a finely crushed solid. The mixing stage 20 is performed manually, for example using a mortar and pestle or by mixing the contents of the platinum crucible with a rod or spoon. The phosphate ore 24 can either be the pre-treated phosphate ore or crushed (phosphate) ore.

At an industrial scale, such use of a platinum crucible would not be economical. At an industrial scale, the carbonate-based flux 22 and phosphate ore 24 may instead be mechanically mixed. The inventor postulates that the mechanical mixing can comprise pouring the carbonate-based flux 22 and the phosphate ore 24 from separate vessels (e.g. hoppers), at an appropriate rate to give the desired flux to ore ratio, into a common vessel. As the carbonate-based flux 22 and the phosphate ore 24 are poured, they mix together. Alternatively, the phosphate ore 24 can be poured directly into a heated carbonate-based flux 22. The heated carbonate-based flux 22 can be in the form of molten carbonate-based flux.

The mass of the carbonate-based flux 22 added to the platinum crucible is greater than the mass of the phosphate ore comprising rare earth elements 24. This is to ensure there is sufficient carbonate-based flux 22 to dissolve the phosphate ore 24.

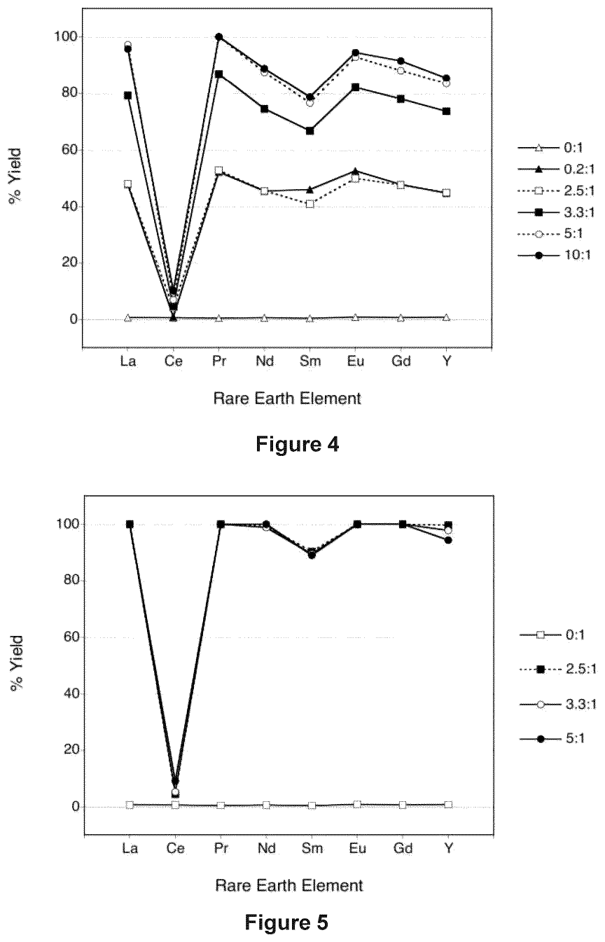

The mass ratio of the carbonate-based flux 22 to the phosphate ore 24 is preferably at least 2:1. A ratio of 2.5:1 extracts at least 50% of the rare earth elements. The effect of the mass ratio on the recovery of the rare earths is further described in Examples 3, 5 and 7 with reference to FIG. 4, FIG. 5 and FIGS. 8 to 10. The inventor notes that the starting monazite used in Examples 3 and 4 was not pure, with XRD patterns revealing the presence of a cerium oxide (CeO₂) phase within the monazite phase. Such a material will obscure to some extent the elegance, simplicity and effectiveness of the process, which would otherwise be revealed through the use of a more purified starting material. However, the effectiveness of the process in recovering rare earth elements from naturally occurring monazite is shown in Example 5, with reference to FIG. 8.

The phosphate ore 24 may comprise one or more rare earth element bearing phosphate minerals. The minerals may comprise monazite [(Ce,La,Nd,Th)PO₄], xenotime [YPO₄] or apatite [Ca₃(PO₄)₅(F,Cl,OH)]. It will be appreciated that monazite and xenotime are more economically important than apatite, as they contain higher quantities of rare earth elements—apatite does not contain rare earths in its chemical formula. It will also be appreciated that many rare earth elements can substitute for Ce and/or Y in the chemical structures. These minerals may therefore comprise the full suite of rare earth elements: La, Ce, Pr, Nd, Sm, Eu, Gd, Tb, Dy, Ho, Er, Tm, Yb, Lu plus Y.

The carbonate-based flux 22 is preferably a sodium carbonate- and/or potassium carbonate-based flux. This is because sodium/potassium carbonate fluxes melt before they decompose at ambient pressure. This allows a next stage in the process, namely, a thermal treatment stage 30 to be performed at ambient pressure. Mixtures of sodium and potassium carbonates also exhibit lower melting points compared to mixtures of magnesium and calcium carbonates.

Typically, the carbonate-based flux 22 also comprises chloride, in the form of sodium chloride and/or potassium chloride. The chloride acts to lower the melting point of the carbonate-based flux, reducing the temperature at which the thermal treatment stage 30 is performed. One particularly suitable flux comprises about 30% sodium chloride, about 50% potassium carbonate and about 20% potassium chloride, as will be further described in the Examples 3 to 5 and Example 7 below. This composition has a melting point of 575° C. The melting point may be further lowered by additions of other elements, however, care is taken not to add too many additional elements. Without wishing to be bound by theory, other elements that could be added include lithium (e.g. as lithium chloride and/or lithium carbonate) or chlorides and/or carbonates of other elements.

Another particularly suitable flux comprises about 60% sodium carbonate and about 40% sodium chloride by weight (i.e. the sodium carbonate—sodium chloride eutectic composition), as is also further described in the Examples below. This flux composition is particularly advantageous because the cost of both sodium carbonate and sodium chloride are substantially lower than the cost of potassium carbonate.

Thus, using this sodium carbonate-based flux may reduce the cost of the process overall. This composition has a melting point of about 632° C. Again, the melting point may be further lowered by additions of other elements, however, care is taken not to add too many additional elements. For example, other elements that could be added include lithium (e.g. as lithium chloride and/or lithium carbonate) or chlorides and/or carbonates of other elements such as calcium or strontium or barium.

Alternatively or additionally, the carbonate-based flux 22 also comprises fluoride, typically in the form of sodium fluoride and/or potassium fluoride. The presence of fluoride in the carbonate-based flux acts to lower the melting point of the carbonate-based flux, reducing the temperature at which the thermal treatment stage 30 is performed. Without wishing to be bound by theory, the inventor postulates that carbonate-based fluxes 22 that additionally comprise one or more fluorides may exhibit lower melting points. For example, a carbonate flux without chloride but with fluoride added is observed to have a lower melting point. Such a flux can comprise sodium carbonate and sodium fluoride. As another example, a carbonate flux with chloride and added fluoride is observed to have a lower melting point.

The mixture 26 of carbonate-based flux and phosphate ore is next subject to the thermal treatment stage 30 of process 10. In the process of FIG. 1, the platinum crucible comprising the mixture of phosphate ore 24 and carbonate-based flux 22 is passed to and subjected to the thermal treatment. The thermal treatment stage 30 is operated to cause substantially all the rare earth elements to be released from the phosphate ore and form new rare earth element compounds on cooling. The new rare earth element compounds are soluble in acid. Without wishing to be bound by theory, the inventory postulates that the new rare earth element compounds are comprised primarily of carbonate and/or oxide compounds. This is because rare earth element carbonates and rare earth element oxides are known to be soluble in acid.

The thermal treatment stage 30 comprises a furnace. In a heating step of thermal treatment, the mixture 26 is heated and held at a temperature greater than the melting point of the carbonate-based flux, typically in the range of approximately 500-650 C°. The temperature of the furnace is selected to be about 50° C. higher than the melting point of the carbonate-based flux, the melting point being dependent on the composition of the flux. In this regard, the heating step may comprise temperatures up to about 800° C., for example when the carbonate-based flux has a melting point of about 750° C.

As above, the heating step can require temperatures of about 800° C. or greater. For example, to facilitate reaction between the flux and mineral. The mixture 26 is heated by placing the platinum crucible in the furnace. Typically, the furnace takes the form of a box furnace which operates at ambient pressure. At the elevated temperature, the carbonate-based flux melts, producing a molten carbonate-based flux. The mixture 26 in the platinum crucible is held in the furnace at the elevated temperature for a set time.

As the mixture 26 is held at the elevated temperature, the phosphate ore comprising rare earth elements dissolves in the molten-carbonate based flux. The dissolution releases the rare earth elements from the phosphate mineral structure. On cooling, the rare earth elements partition into the carbonate phase and form new rare earth element compounds, most likely carbonate and/or oxide compounds. The inventor notes that this is effectively the reverse of how the phosphate ore comprising rare earth elements was formed in the first place.

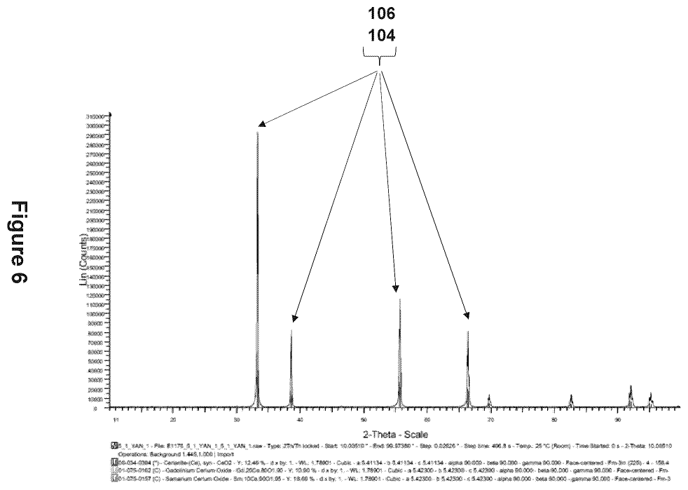

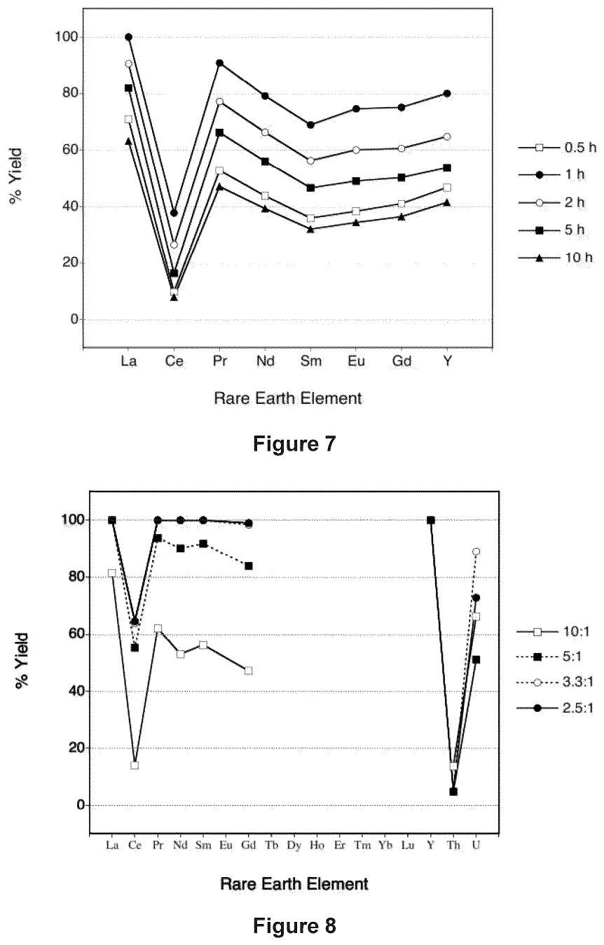

The predetermined time for the heating is sufficient to allow the phosphate ore to substantially dissolve. This allows nearly complete recovery of the rare earth elements from the phosphate ore structure. However, if the predetermined time is too long, the carbonate-based flux starts to decarbonate, reducing the recovery of rare earth elements, as well as the recovery of the flux. This effect is described more fully in Example 4 with reference to FIG. 7. To balance these trade-offs, an effective predetermined time in the furnace is about 2 hours.

The platinum crucible is a suitable vessel for the mixing 20 and thermal treatment 30 in a laboratory setting. It will be appreciated that, as the process is scaled up, an alternative vessel will be required. Without wishing to be bound by theory, the inventor anticipates that a steel shell lined with layers of refractory insulation and barrier materials, similar to that used for the processing of aluminium, would be suitable for performing the disclosed process on an industrial scale. Such a vessel would also replace the need for a box furnace as the contents of the vessel are heated either directly or indirectly in situ. Again, the industrial scale vessel would typically operate at ambient pressure.

After the predetermined time has elapsed, the mixture is allowed to cool and solidify in the platinum crucible, thereby producing a cooled solid 32. Cooling is simply achieved by turning the heating element of the furnace off and allowing the mixture of dissolved phosphate ore and molten carbonate-based flux to cool inside the furnace, as the furnace cools. The cooled solid 32 comprises the new rare earth element compounds and residue phosphate minerals, as well as residual (unreacted) solid carbonate-based flux material.

The cooling is typically fast enough to ensure the rare earth elements form the new (acid soluble) rare earth element compounds and do not recrystallise as phosphate minerals. The cooling seeks to depart from the natural formation of phosphate ores comprising rare earth elements (i.e. as carbonatites cool slowly the rare earth element phosphate minerals crystallise out from the melt). As described in more detail in the Examples, allowing the mixture to cool inside the furnace, with the heating element off, produces a rate of cooling that is sufficiently fast to ensure that acid soluble rare earth element (i.e. hypothesised to be carbonate and/or oxide) minerals are formed.

The cooled solid 32 undergoes an optional crushing stage 40. The purpose of the crushing stage 40 is to produce fine size particles for subsequent treatment stages. Crushing ensures the residual carbonate-based flux is accessible for a water wash stage 50 and that the new rare earth element compounds are accessible for an acid wash stage 60.

Crushing is typically employed because, as the mixture of dissolved phosphate ore and molten carbonate-based flux is cooled, it can agglomerate forming large particles. In the agglomerates, not all the new rare earth element compounds are directly accessible as they may be bound within other phases. Typically, the cooled solid 32 will be in the form of masses of small interlocking crystals. On a laboratory scale, the crushing stage 40 comprises using a mortar and pestle to grind the solid until fine homogeneous particles are formed. On an industrial scale, the crushing stage 40 may comprise a mill, for example a ball mill. As the cooled solid 32 is friable, only light crushing of the cooled solid 32 is required. For example, the energy required to crush the cooled solid 32 is only a fraction of the energy required to crush ore in e.g. a pre-treatment stage. The crushed solid 42 is passed to the water wash stage 50.

In the water wash stage 50, the crushed solid 42 is washed with water 52. The water 52 used for washing 50 the crushed solid 42 can be either recovered process water or fresh water. The water wash stage 50 can be performed as either a batch or continuous process. For example, the crushed solid and water can be held in a vessel for a set time, with the vessel subject to agitation to promote mixing therein (i.e. as a batch process). Alternatively, the crushed solid and water can be passed through several vessels in series (e.g. continuously stirred tank reactors—i.e. as a continuous process).

Because the residual carbonate-based flux present in the crushed solid 42 is highly soluble in water, by washing the crushed solid 52 with water, the residual carbonate-based flux is substantially dissolved in the water, thereby forming a solution 54 comprising the carbonate-based flux. Any soluble impurities in the water 52 used for washing 50 (for example salts) will also be contained within the solution comprising the carbonate-based flux 54. The source of wash water 52 can be determined beforehand. For example, if recovered process water is sufficiently pure, this can be used as the wash water 52. Under these conditions, the rare earth element compounds are only negligibly dissolved by the water wash stage 50.

When the flux 22 comprises sodium and/or potassium (i.e. as sodium carbonate, sodium chloride, potassium carbonate and/or potassium chloride), the solution 54 comprising the carbonate-based flux also comprises phosphate that on evaporation would produce sodium phosphate, possibly trisodium phosphate, and/or potassium phosphate. This is because, when the flux 22 comprises sodium carbonate and/or potassium carbonate, some or all of the phosphate in the ore 24 is converted to sodium phosphate and/or potassium phosphate. In particular, during thermal treatment, phosphate from the phosphate ore can dissolve in the carbonate-based flux. During cooling, the phosphate then forms sodium phosphate and/or potassium phosphate. The resulting sodium phosphate and/or potassium phosphate, being soluble in water, dissolves in the wash water 52 during washing 50. In this regard, the solution 54 comprises sodium phosphate and/or potassium phosphate, as well as the carbonate-based flux.

The solution 54 and remaining solid 56 are separated, for example, using filtration or by decanting. Typically, the separated solution 54 is recycled for further treatment in a flux and phosphate recovery stage 60 to recover the carbonate-based flux as a solid 62 substantially free of liquid.

In the flux and phosphate recovery stage 60, sodium phosphate and/or potassium phosphate 57 and the carbonate-based flux 62 are recovered from the solution 54 as individual products. FIG. 1A shows an embodiment of the flux and phosphate recovery stage 60 in which fractional crystallisation is used to separate the sodium phosphate and/or potassium phosphate and the carbonate-based flux. In the illustrated embodiment, the flux and phosphate recovery stage 60 employs fractional crystallisation to recover the carbonate-based flux and the sodium phosphate and/or potassium phosphate from the solution 54. In particular, the flux and phosphate recovery stage 60 comprises at least three crystallisation stages 61, 64, 65. The crystallisation stages are operated as follows:
Stage 1: carbonate-based flux values are crystallised;
Stage 2: a mixture of carbonate-based flux values, sodium phosphate and/or potassium phosphate are crystallised; and
Stage 3: the remaining sodium phosphate and/or potassium phosphate is crystallised.

In this regard, the first crystallisation stage 61 comprises at least an evaporation stage wherein the water is evaporated from the solution 54 in an evaporation vessel. As water is evaporated from the solution 54, the carbonate-based flux values start to form crystals of carbonate-based flux values within the solution 54. At the same time, the concentration of sodium phosphate and/or potassium phosphate within the solution 54 increases.

Water is evaporated from the solution 54 until the sodium phosphate and/or potassium phosphate starts to form crystals. At this point, the evaporation of water from the solution is terminated (heating terminated). This maximises the recovery of the carbonate-based flux and minimises the extent to which the sodium phosphate and/or potassium phosphate affects the purity of the recovered carbonate-based flux. At least a portion of the water evaporated from the solution 54 can be reused 55 as wash water 52.

It will be appreciated that the type of evaporation vessel employed will be dependent on scale. For a small-scale operation, a single-effect evaporator is appropriate. Conversely, an industrial scale process will typically employ multi-stage evaporation. The vapour produced is collected for use either as process water 55, or it can be passed to a mechanical vapour recompression system to produce steam that can be used to heat the evaporator(s) in the first instance.

When the evaporation stage is operated to form crystals of carbonate-based flux values within the solution 54, the first crystallisation stage 61 will comprise a second separation (e.g. filtration) stage, wherein a solid substantially free of liquid 62 is separated from remaining liquid. The solid 62 comprises carbonate-based flux and may also include contaminants introduced with the water 52 during the water wash stage 50.

Typically, the resultant solid 62 is recycled and comprises at least a portion of the molten carbonate-based flux 22 introduced to the mixing stage 20. This reduces the mass of fresh carbonate-based flux 22 required by the process 10. Advantageously, this can reduce the cost of the process 10.

The solution 66 separated from the solid 62 comprises sodium phosphate and/or potassium phosphate, as well as some carbonate-based flux values. The solution 66 is passed to a second crystallisation stage 64 in which the remaining carbonate-based flux values, along with some of the sodium phosphate and/or potassium phosphate are crystallised from the solution 66.

In this regard, the second crystallisation stage 64 comprises at least an evaporation stage wherein the water is evaporated from the solution 66 in an evaporation vessel. As water is evaporated from the solution 66, the remaining carbonate-based flux values crystallises therefrom. At the same time, sodium phosphate and/or potassium phosphate will form crystals of sodium phosphate and/or potassium phosphate within the solution 66.

Typically, water is evaporated from the solution 66 until all the carbonate-based flux values have been precipitated as crystals. At least a portion of the water evaporated from the solution 66 can be reused 55 as wash water 52.

As above, it will be appreciated that the type of evaporation vessel employed will be dependent on scale, with a single-effect evaporator being appropriate on a small-scale, but with an industrial scale process employing multi-stage evaporation.

When the evaporation stage is operated to form crystals of carbonate-based flux values and sodium phosphate and/or potassium phosphate within the solution 66, the second crystallisation stage 64 will comprise a second separation (e.g. filtration) stage, wherein a solid substantially free of liquid 67 is separated from remaining liquid. The solid 67 comprises carbonate-based flux values as well as sodium phosphate and/or potassium phosphate. Typically, this solid 67 is discarded as waste.

It is noted that, where the flux comprises chloride, a portion of the carbonate component of the flux would crystallise in stage 61, with the remaining carbonate component of the flux crystallising in stage 64. However, the chloride values would not crystallise in either stage 61 or stage 64. In this regard, after the carbonate component of the carbonate flux has finished crystallising concurrently with the phosphate, the remaining solution still comprises the chloride component of the flux, as well as the sodium phosphate and/or potassium phosphate. The remaining solution 63 primarily comprises sodium phosphate and/or potassium phosphate (and chloride when the flux comprises chloride) and is passed to the third crystallisation stage 65. The third crystallisation stage 65 comprises at least an evaporation stage wherein the water is evaporated from the solution 63 in an evaporation vessel. As water is evaporated from the solution 63, the remaining sodium phosphate and/or potassium phosphate crystallise therefrom.

Typically, water is evaporated from the solution 63 until all the sodium phosphate and/or potassium phosphate has crystallised. At least a portion of the water evaporated from the solution 63 can be reused 55 as wash water 52.

As above, it will be appreciated that the type of evaporation vessel employed will be dependent on scale, with a single-effect evaporator being appropriate on a small-scale, but with an industrial scale process employing multi-stage evaporation.

When the evaporation stage is operated to form crystals of sodium phosphate and/or potassium phosphate, the third crystallisation stage 65 will comprise a second separation (e.g. filtration) stage, wherein a solid 57 substantially free of liquid is separated from remaining liquid 69. The solid 57 comprises sodium phosphate and/or potassium phosphate. The remaining liquid 69 can be collected for re-use in the process, e.g. as process water.

As above, when the carbonate-based flux comprises a chloride, the chloride component tends not to crystallise in stage 65. In this regard, the liquid 69 still comprises the chloride component of the carbonate-based flux and is evaporated again to regenerate the NaCl (and/or KCl as the case may be).

The crystallised sodium phosphate and/or potassium phosphate 57 is collected and may be sold directly as a by-product of the process 10. Alternatively, the crystallised sodium phosphate and/or potassium phosphate 57 may be subjected to further processing to separate the sodium phosphate and the potassium phosphate (when both are present). The recovered sodium phosphate and potassium phosphate can then be sold as individual by-products. For example, sodium phosphate can be used as a fertiliser, or as a feedstock for fertilisers, and is also used as a cleaning agent, lubricant, food additive, stain remover and degreaser.

Thus, it will be appreciated that, depending on the flux composition, the multi-stage crystallisation and separation stages are varied. In particular, the number of stages can vary with flux and flux to mineral ratio. Also, the operating conditions of each crystallisation stage will vary depending on the composition of the carbonate-based flux, as well as the concentrations of the phosphates (sodium and/or potassium). For example, insofar as separation is concerned, the concentrations are important relative to that of the flux. In this regard, the concentrations will continuously change with evaporation relative to the concentrations of the flux components in the solution 54. For more complex carbonate-based fluxes (i.e. those which comprise more components), further crystallisation stage(s) may be required. Additionally, careful control of each stage is required to maximise the recovery of each component of the carbonate-based flux, as well as the sodium phosphate and/or potassium phosphate. In this regard, the flux and phosphate recovery stage 60 can be quite complex, because the carbonate-based flux can comprise several components, resulting in different relative concentrations of the components of the carbonate-based flux and the sodium phosphate and/or potassium phosphate.

For example, when the carbonate-based flux comprises sodium carbonate and sodium chloride, the carbonate-based flux values crystallised in the first crystallisation stage may only comprise sodium carbonate, because of the relative concentrations of sodium carbonate and sodium chloride and the higher solubility of sodium chloride. As above, in a second crystallisation stage, a mixed sodium carbonate/sodium phosphate product is produced and in a third crystallisation stage, sodium phosphate is crystallised. The solution separated from the sodium phosphate crystal still comprises sodium chloride, with the flux and phosphate recovery stage 60 comprising one or more additional crystallisation stage(s) in which sodium chloride is recovered.

Similarly, it will be appreciated that the amount of each crystallised product (carbonate-based flux 62, waste 67, sodium phosphate and/or potassium phosphate 57) will vary depending on the composition of the carbonate-based flux, as well as the concentrations of the phosphates (sodium and/or potassium) relative to those of the flux components in the solution 54.

The crushed solid 56 produced by e.g. filtration in the water wash stage, and which is now depleted of carbonate-based flux, comprises primarily the new (likely carbonate and/or oxide) rare earth element compounds and phosphate ore residue. The flux-depleted solid 56 is collected and is passed to and subjected to an acid wash stage 70. The acid wash stage 70 is operated so as to cause the rare earth element compounds to substantially dissolve from the flux-depleted solid 56.

During the acid wash stage 70, the flux-depleted solid 56 is washed with an acid 72. The washing is performed at ambient temperature and pressure in one or more vessels as either a batch or continuous process. Washing is performed using nitric acid at a concentration of about 1 M. The inventor postulates that other strong acids can also be used for washing the flux-depleted solid 56—for example hydrochloric or sulphuric acid. The concentration of the acid is selected to provide high recovery of rare earth element compounds into solution.

As the rare earth element compounds produced are soluble in acid, by washing the flux-depleted solid 56 with the acid 72, the rare earth element compounds are caused to dissolve from the solid 56 to produce a solution 72 comprising rare earth elements and a solid (i.e. rare-earth-depleted) residue 74.

The solution 72 comprising rare earth elements is separated 75 from the solid residue 74 such as by filtration or decanting. Without wishing to be bound by theory, the inventor postulates the solid residue 74 will comprise primarily cerium (IV) oxide (CeO₂), thorium oxide (ThO₂), and some phosphate. The solid residue 74 is collected. If it comprises thorium, the solid residue 74 is radioactive and must be handled appropriately. For example, the solid residue 74 can be discarded as radioactive waste. Alternatively, if it is economical to do so, the solid residue 74 can be subjected to further processing to recover the thorium and/or cerium therefrom. The recovered thorium and/or cerium can then be sold as products. The remaining residue (i.e. the solid remaining after extraction of the thorium and/or cerium) is discarded as waste.

The solution 72 comprising rare earth elements can be further treated 80, using methods known in the art (e.g. by the addition of oxalic acid), to produce rare earth element products 82. This further treatment can occur as part of the process disclosed herein. Alternatively, the solution comprising rare earth elements can be pumped or transported to another facility for further treatment, however this option is expensive. Another alternative is that the solution 72 comprising rare earth elements is passed to an evaporation stage, wherein a solid substantially free of liquid comprising the rare earth elements is formed. The solid substantially free of liquid comprising the rare earth elements is then transported to a separate facility wherein individual rare earth elements are separated. The logistics of transporting a solid compared to a liquid are easier, and the cost per unit of rare earth element is significantly lower.

As aforementioned, phosphate ores comprising rare earth elements will typically contain uranium and thorium in variable quantities. These elements are radioactive and therefore require appropriate handling and disposal.

The uranium dissolves during the acid wash stage 70 and will therefore be in the solution comprising rare earth elements 72. This occurrence is described in further detail below in Examples 3 to 7.

Without wishing to be bound by theory, the inventor hypothesises that to safely recover uranium, the uranium may be precipitated from the solution comprising rare earth elements 72 as an oxide. The solution 72 is then filtered and the uranium oxide solid is collected for safe disposal. The uranium may otherwise be removed from the solution 72 using established techniques. The uranium-free solution can then be further treated to recover the rare earth elements therein.

Depending on the conditions of the thermal treatment stage 30, the thorium will either be present primarily in the residue 74 or in the solution comprising the rare earth elements 72. This is described in further detail below in Examples 3 to 7.

When the thorium remains in the residue 74, no further treatment is required. The residue 74 is then radioactive and is disposed of appropriately. When the thorium is present in the solution comprising the rare earth elements 72, it is removed from the solution, for example by precipitating it as thorium oxide. The thorium oxide solid is then filtered and collected for safe disposal. Without wishing to be bound by theory, the inventor postulates that an alternative to precipitation and filtration could be the use of electrolysis to separate thorium from the solution. However, the inventor notes that electrolysis is expensive due to the cost of electricity and thus may not be economical on a large scale. The thorium-free solution can then be further treated to recover the rare earth elements therein.

It will be appreciated that the process 10 is not limited to a phosphate ore comprising rare earth elements. The process can be applied to other ores that have similarly been formed from carbonatite melts or are soluble in carbonatite melts. For example, the process may be applied to recover elements such as niobium, tantalum, titanium or zirconium from oxide ores such as pyrochlore, columbite, tantalite, fersmite, ilmenite and zircon. The process may also be applied to recover rare earth elements from the silicate eudialyte and to recover lithium from spodumene. It will be appreciated that this list is not exhaustive as there are many minerals that can be dissolved by carbonatite melts.

For oxide and silicate ores, the process 10 comprises the same stages as afore-described. However, during the thermal treatment stage 30, without wishing to be bound by theory, the inventor postulates that the oxide/silicate ore will dissolve in the molten carbonate-based flux to therein form simple oxides. For example, pyrochlore [Ca₂Nb₂O₇] may form the oxides Nb₂O₅ and CaO (or CaCO₃). The simple oxides could then be separated from a residue, for example, by density separation. When oxide and/or silicate ores are used as feed to the process 10, the carbonate-based flux will typically comprise one or more chlorides. Additionally, it is thought that the addition of silica and/or phosphate to the carbonate-based flux may increase the solubility of the oxide/silicate ore. This can increase the recovery of metals from these minerals. In some cases, the temperature of the heating step may be as high as above about 800° C. Such temperatures can be required to facilitate the reaction between the ore and the flux. For example, in the case of recovering zirconium from zircon, the heating step can require temperatures up to about 850° C.

### EXAMPLES

Non-limiting examples will now be described, to further illustrate the process for recovering rare earth elements from phosphate ores using a carbonate-based flux. In each of the Examples 3 to 8, the powdered phosphate mineral was mixed with a suitable carbonate-based flux in a platinum crucible. The samples were put into a box furnace at 50° C. above the expected melting temperature of the carbonate-based flux and left for a predetermined time, to allow the ore to fully dissolve. After the sample was removed from the furnace, it was crushed into a fine powder using a mortar and pestle until it was homogeneous in size.

Approximately 0.105 g of each sample was then added to 10 mL of warm tap water in a 15 mL centrifuge tube and placed in an ultrasonic bath for 2 min. The resultant solution was then left for 2 h. After 2 h, the water solution was collected for analysis. The remaining residue in the tube was weighed and added to 10 mL of warm 1 M HNO₃ and placed in an ultrasonic bath for 2 min. The acid solution was then left for 2 h. After 2 h, the acid solution was collected for analysis.

The two sets of solutions gathered from the leach process were analysed using an Agilent ICP-OES 5110. To ensure the concentrations fitted within the analytical parameters of the instrument, portions of each leach solution were diluted by a factor of 1:10 with dilute HNO₃. Five standards of rare earth elements were made using the standard solution ICP-OES IQ1 at concentrations of 0.1 ppm, 1 ppm, 10 ppm, 50 ppm, and 100 ppm.

The concentration of rare earth elements in the water and nitric acid solutions were used to calculate the recovery from the phosphate mineral.

For each rare earth element, the recovery was calculated as a ratio of the mass extracted versus the mass in the ore initially. The recovery calculation assumed 100% of the rare earth element was hosted by the phosphate in the ore initially and was thus accessible for extraction by this process.

The process was tested using three different phosphate minerals: a synthetic monazite, a naturally occurring monazite and a naturally occurring xenotime. The synthetic monazite was prepared in the laboratory from analytical grade reagents. The methodology is illustrated by way of Example 1.

Three different carbonate-based fluxes were also tested: a eutectic Na₂CO₃—K₂CO₃—KCl composition, a composition based on the naturally occurring carbonate melt erupted from Oldoinyo Lengai, and a eutectic Na₂CO₃—NaCl composition. All fluxes were prepared in the laboratory from analytical grade reagents. The methodology is illustrated by way of Example 2.

A first set of experiments were run in which different ratios of the phosphate mineral to carbonate-based flux were trialled, including the use of no carbonate-based flux. These experiments were run using two flux compositions: the eutectic Na₂CO₃—K₂CO₃—KCl composition and the composition based on the Oldoinyo Lengai carbonate melt individually. For consistency, the mixture of the phosphate mineral and carbonate-based flux were placed in the box furnace for 3 h at a temperature 50° C. above the melting point of the respective flux.

For synthetic monazite only, a second set of experiments were performed where the predetermined time for which the samples were put into the box furnace at 50° C. above the melting temperature of the carbonate-based flux was varied. These experiments were performed using only the eutectic Na₂CO₃—K₂CO₃—KCl composition as a flux and were performed with a mass ratio of flux to phosphate mineral of 5:1.

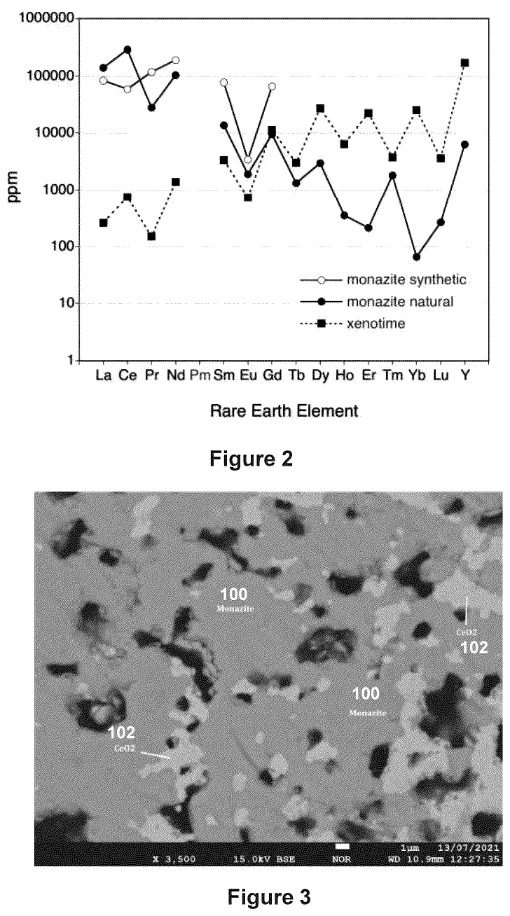

FIG. 2 provides the composition in ppm of rare earth elements in samples of the synthetic monazite, natural monazite and xenotime used in the experiments. The natural xenotime contained the entire suite of rare earth elements but was enriched in heavy rare earth elements. The natural monazite contained the entire suite of rare earth elements but was enriched in light rare earth elements. The synthetic monazite was synthesised to only contain the light rare earth elements plus Yb.

For natural monazite only, a third set of experiments were performed in which the eutectic Na₂CO₃—NaCl carbonate-based flux was used at a mass ratio of flux to phosphate mineral of 4:1. The samples were put into the box furnace at 650° C. and the predetermined time for which the samples were put into the box furnace was varied.

The applicability of the process to other (non-phosphate) ores was tested and is shown by way of Example 8. In particular, the process was tested using zircon (ZrSiO₄) and the eutectic Na₂CO₃—NaCl carbonate-based flux.

### Example 1—Preparation of Synthetic Monazite

A synthetic monazite mixture was created for use in the rare earth element extraction process. The mixture was based on the monazite composition from Rapp and Watson (1986) (Monazite solubility and dissolution kinetics: implications for the thorium and light rare earth chemistry of felsic magmas. Contributions to Mineralogy and Petrology, 94, 304-316. https://doi.org/10.1007/BF00371439) with the exclusion of CaO, ThO₂ and U₃O₈. The synthetic monazite mix composition is provided in Table 1 below. The mixture was created using analytical grade reagents.

The mixture of the reagents was pressed into pellets and fired overnight at 1400° C. in air in a one-atmosphere Gero gas-mixing tube furnace. The pellet was removed, crushed, repressed into a pellet, and refired. The double firing aimed to redistribute unreacted starting materials to increase the yield of monazite. Once the second firing was completed, the pellet was powdered.

TABLE 1
Synthetic monazite composition.

| | Mass Fraction (%) |
|---|---|
| Ce₂O₃ | 27.63 |
| P₂O₅ | 30.87 |
| La₂O₃ | 6.75 |
| Pr₂O₃ | 4.14 |
| Nd₂O₃ | 16.50 |
| Sm₂O₃ | 7.08 |
| Eu₂O₃ | 0.33 |
| Gd₂O₃ | 4.83 |
| Y₂O₃ | 1.87 |

FIG. 3 is a back-scattered electron image taken using a JEOL 8530F Plus Electron Probe Microanalyzer of a sample of the synthetic monazite. The image showed at least two distinct phases present within the sample: a monazite phase 100 and a cerium oxide (CeO₂) phase 102.

From the compositional analysis, the Ce₂O₃ concentration in the monazite phase itself was almost four times lower than the amount put into the monazite mix before firing (˜7 wt % in monazite from microprobe versus 26.6 wt % the monazite mix). This implied that only a portion of the Ce was hosted in the monazite. The remaining Ce was hosted in the oxide form.

It will be appreciated that, since the recovery calculation for Ce was based on the mass of Ce in the synthetic monazite mixture initially, the yield percentage values for all (synthetic monazite) experiments were significantly lower than expected. This was because the majority of Ce present in the synthetic monazite is CeO₂ which was insoluble in the carbonate flux.

Two different synthetic monazites were prepared. The first synthetic monazite was used for the first series of experiments which involved trialling different carbonate-based fluxes and different ratios of the flux to monazite. The second synthetic monazite was used for the second series of experiments which involved different heating times. Both synthetic monazites exhibited the same CeO₂ phase.

The presence of the CeO₂ phase was a direct consequence of the fact the monazite was synthetic (prepared in a laboratory setting). Such a phase is not typical of naturally occurring monazites. Despite the presence of the CeO₂ impurity, extraction of rare earth elements from the samples was still observed demonstrating the process disclosed herein was effective.

### Example 2—Preparation of Carbonate Fluxes

All carbonate-based fluxes were prepared in the laboratory using analytical grade reagents. The first flux was based on the eutectic Na₂CO₃—K₂CO₃—KCl composition reported by Yan et al. (2019) (Preparation and Experimental Study of Three Element Mixed Molten Salt. IOP Conferences Series Materials Science Engineering. 585. https.//doi.org/10.1088/1757-899X/585/1/012010) (herein referred to as the “eutectic Na₂CO₃—K₂CO₃—KCl”). The second flux was based on a simplified composition of the carbonate melt erupted from Oldoinyo Lengai (herein referred to as “synthetic Oldoinyo Lengai”). The third flux was based on the eutectic Na₂CO₃—NaCl composition.

To determine the melting points of the carbonate fluxes, a sample of each flux was pelletised and loaded onto a metallic plate. The plate was then placed inside a Linkam TS1400 heating stage attached to an Olympus BX60 microscope. The temperature of the heating stage was calibrated using a fluid inclusion standard for H₂O/CO₂ at −56.6° C., a series of organic compounds at a temperature span of 80-230 ° C. and silver at 962° C. All measurements were done in an atmosphere of nitrogen gas at a constant flow rate. A heating rate of 50° C./min was used from room temperature until about 50° C. below the expected melting point. The heating rate was then slowed to 20° C./min for the next 40° C. and then set to 6° C./min until the pellets started to change shape and “flow”. This was defined as the melting point. The heating process was optically viewed. The accuracy and precision of the instrument were monitored by comparing melting points determined for physical mixture of K₂CO₃ and Na₂CO₃ with those in the literature (Reisman, A., 1959. Heterogeneous equilibria in the system K2CO3—Na2CO3. Journal of the American Chemical Society 81, 807-811). Table 2 shows the three carbonate flux compositions and the melting points.

TABLE 2
Composition and melting points of three carbonate-based fluxes
used to recover rare earth elements from phosphate ores.

| | | | Synthetic | |
|---|---|---|---|---|
| | | Eutectic | Oldoinyo | Eutectic |
| | | Na₂CO₃—K₂CO₃—KCl | Lengai | Na₂CO₃—NaCl |
| Composition | Na₂CO₃ | 30.00 | 55.77 | 60 |
| (wt %) | K₂CO₃ | 50.00 | 11.11 | — |
| | CaCO₃ | — | 25.01 | — |
| | SrCO₃ | — | 2.31 | — |
| | BaCO₃ | — | 1.71 | — |
| | NaCl | — | 4.09 | 40 |
| | KCl | 20.00 | — | — |

| | | | |
|---|---|---|---|
| Melting Point (° C.) | 568 | 750 | 632 |

The melting point of the synthetic Oldoinyo Lengai flux was higher than the carbonate melt erupted naturally by Oldoinyo Lengai. This was because the natural carbonate melt contained other elements such as fluorides that were not included in the synthetic analogue of the Oldoinyo Lengai flux for simplicity/safety reasons.

### Example 3—Synthetic Monazite: Carbonate Ratio

In the first set of experiments, samples of synthetic monazite were separately mixed with the eutectic Na₂CO₃—K₂CO₃—KCl and the synthetic Oldoinyo Lengai carbonate-based fluxes and subjected to the experimental procedure afore-described. For the eutectic Na₂CO₃—K₂CO₃—KCl flux, the following mass ratios of flux to synthetic monazite were tested: 0.2:1, 2.5:1, 3.3:1, 5:1, 10:1. For the synthetic Oldoinyo Lengai flux, the following mass ratios of flux to synthetic monazite were tested: 2.5:1, 3.3:1, 5:1. The experimental procedure was also performed on a sample of only synthetic monazite (that is, no flux) for comparison.

FIGS. 4 and 5 show the percentage recovery of La, Ce, Pr, Nd, Sm, Eu, Gd and Y when the eutectic Na₂CO₃—K₂CO₃—KCl and synthetic Oldoinyo Lengai were used as the carbonate-based flux respectively.

Both FIGS. 4 and 5 indicated that the carbonate-based flux was necessary to extract the rare earths from the synthetic monazite. That is, when no carbonate-based flux was present, <1% of the rare earth elements were extracted. Conversely, the effectiveness of the process in recovering rare earths using a carbonate-based flux was demonstrated. The results showed that, under certain conditions, nearly 100% of the rare earths were extracted.

For the eutectic Na₂CO₃—K₂CO₃—KCl carbonate-based flux, the extraction was increased as the ratio of the carbonate-based flux to the monazite was increased. At a mass ratio of 10:1, essentially all the La, Pr, Nd, Eu, Gd and Y were extracted. The majority of the Sm was also extracted. The (slightly) lower recovery of Sm was postulated to be an analytical artefact. The lowest extraction was observed for the ratios 0.2:1 and 2.5:1, where approximately 50% of all elements, with the exception of Ce, were extracted. This showed that a ratio of at least 2.5:1 was desirable, in order to extract at least 50% of the rare earth elements.

Commercially, it is undesirable to have a ratio of flux to monazite that is too high, as this represents a large flux requirement. This may increase the cost of the flux recovery stage 60 (FIG. 1)—e.g. bigger evaporators requiring more energy. It was noted therefore that a balance between the flux requirement and the recovery of the rare earth elements would be required. It was also noted that, if the recovery of the rare earth elements was less than 100%, a portion of the solid residue 74 can be recycled back to the mixing stage 20 for further processing.

Across all ratios of flux to synthetic monazite, the extraction of Ce was significantly lower than the other rare earth elements. Without wishing to be bound by theory, the inventor hypothesises that the low Ce yield was due to the formation of an insoluble Ce oxide phase during the synthesis of the synthetic monazite. As explained in Example 1, the back-scattered electron image of the synthetic monazite (FIG. 3) showed the presence of the Ce oxide phase 102. Since the Ce oxide phase was not soluble in the carbonate melt, the Ce could not be extracted using this method.

The recovery of Ce under certain conditions (e.g. 10:1 flux to monazite ratio) was consistent with at least some of the Ce in the monazite being extracted.

When the synthetic Oldoinyo Lengai carbonate-based flux was used (FIG. 5), nearly 100% recovery of all rare earth elements with the exception of Ce was observed when the flux to mineral ratio was 2.5:1 or greater. This indicated that the Oldoinyo Lengai carbonate-based flux could be effectively used to recover rare earth elements.

Again, the lower recovery of Ce compared with the other rare earth elements was due to the presence of cerium oxide, which accounted for the majority of the Ce in the sample.

Comparing the recoveries achieved by both the eutectic Na₂CO₃—K₂CO₃—KCl and synthetic Oldoinyo Lengai carbonate-based fluxes indicated that the simpler eutectic Na₂CO₃—K₂CO₃—KCl mix was able to recover substantially all the rare earth elements from the phosphate ore. An advantage of the eutectic Na₂CO₃—K₂CO₃—KCl mix was that the melting point of the flux was substantially lower than the melting point of the synthetic Oldoinyo Lengai, allowing the heating to be performed at a lower temperature. The eutectic Na₂CO₃—K₂CO₃—KCl mix was also simpler to synthesise and recover since it did not require the use of additional components such as SrCO₃ or BaCO₃. However, the recovery of rare earths using synthetic Oldoinyo Lengai indicated that a wide range of carbonate-based flux compositions could be used for this process.

### Example 4—Monazite: Time Trials

The time trial experiments were performed on mixes of the synthetic monazite and the eutectic Na₂CO₃—K₂CO₃—KCl carbonate-based flux. The recovery of rare earth elements for different times is shown in FIG. 7.

For all rare earth elements, the recovery of each rare earth element as a function of heating time followed the same trend. In particular, the maximum recovery occurred after 1 h of heating. The minimum recovery occurred after 10 h of heating. Interestingly, the recovery after 30 mins of heating was only slightly higher (<5%) than the recovery after 10 h.

Without wishing to be bound by theory, the inventor postulates that at very short time-frames (e.g. <1 h), there was insufficient time for the carbonate flux to fully melt and to fully dissolve the phosphate ore. Thus, the rare earth elements were not released from the phosphate mineral into a carbonate mineral and could not be dissolved during the acid wash.

Conversely, at longer heating times, the inventor postulates that the low recovery was due to partial decarbonation of the carbonate melt. It is known that Na₂CO₃ starts to decarbonate at around 500° C. Since the furnace temperature was about 625° C., some decarbonation of the flux may be expected. Decarbonation resulted in the breakdown of Na₂CO₃, releasing CO₂. This resulted in less carbonate available in which the monazite could be dissolved.

### Example 5—Natural Monazite: Flux Ratio

In a next set of experiments, samples of natural monazite were mixed with the eutectic Na₂CO₃—K₂CO₃—KCl and subjected to the experimental procedure afore-described. For each flux, the following mass ratios of flux to natural monazite were tested: 10:1, 5:1, 3.3:1, 2.5:1. The predetermined time was 1 hour.

FIG. 8 shows the percentage recovery of La, Ce, Pr, Nd, Sm, Gd, Y, Th and U for each of the mass ratios tested. The percentage recovery for the mass ratios of flux to natural monazite of 2.5:1 and 3.3:1 are nearly equal. The composition of rare earth elements in the natural monazite (FIG. 2) was determined previously.

The carbonate-based flux was able to extract rare earths from natural monazite, with nearly 100% recovery of most elements achievable under certain conditions. The extraction of rare earths was decreased as the ratio of the carbonate-based flux to monazite was increased, but not for U. For U, the maximum yield occurred at a flux to monazite ratio of 3.3:1, with the yield then decreasing as the flux to monazite ratio was decreased to 2.5:1.

The highest extraction was observed for the ratios of 2.5:1 and 3.3:1 for all elements. At these mass ratios, essentially all of the La, Pr, Nd, Sm, Gd and Y were extracted. The yield percent of Gd of just below 100% was thought to be an analytical artefact.

The amount of Th extracted from the natural monazite was low, being below 20% for all ratios of carbonate flux to monazite tested. This indicated that the majority of the Th would be present in the solid residue 74 (see FIG. 1), as it remained in the residue after the acid wash. It was postulated that this was because Th existed in an oxidation state of Th⁴⁺ resulting in the production of ThO₂ during the cooling stage of the thermal treatment 30. ThO₂ is known to be only sparingly soluble in acid. Advantageously, this meant that the Th could be safely disposed of by disposing of the solid residue 74 as radioactive waste.

The extraction of Ce for natural monazite was higher than synthetic monazite, because a lot of the Ce in the synthetic monazite was as CeO₂. This indicated that the process was capable of recovering Ce from phosphate minerals. However, across all ratios of flux to natural monazite, the extraction of Ce was low compared to the other rare earth elements. Ce can exist as both Ce⁴⁺ and Ce³⁺. Whilst Ce³⁺ can form oxides that are soluble in acid, Ce⁴⁺ forms CeO₂, which is insoluble in acid. Although Ce typically exists predominantly as Ce³⁺ in natural monazite, it was postulated the low Ce yield was due to the oxidation of Ce³⁺ into Ce⁴⁺. This occurred because the heating and melting was performed in air.

However, the incomplete extraction of Ce was not considered a substantial problem, because Ce is relatively cheap and abundant compared to the other rare earth elements. Furthermore, the low extraction of Ce may be beneficial in some circumstances. This is because monazite comprises a high concentration of Ce (>100,000 ppm on a normalised basis). If Ce remains in the solid residue, the volume of rare earth element concentrate produced from the solution 72 may be reduced, which can lower the associated shipping costs.

It was noted that the remaining solid residue 74 could be further processed to recover the Th and/or Ce therefrom, if it would be economical to do so.

### Example 6—Natural Monazite: Flux Type

In this experiment, the effectiveness of the eutectic Na₂CO₃—NaCl carbonate-based flux in recovering rare earth elements from natural monazite was tested. The experimental method outlined above was used. In a first experiment, the predetermined time for which the sample was held at 650° C. was 1 hour. In a second experiment, the predetermined time was 2 hours. The yield of La, Ce and Nd for each experiment is provided in the table below.

TABLE 3
Recovery of rare earth elements from natural monazite
for different predetermined heating times.

| | | |
|---|---|---|
| Heating time | 1 hour | 2 hours |

| | | | |
|---|---|---|---|
| Rare earth | La | 84 | 93 |
| element yield | Ce | 71 | 75 |
| (%) | Nd | 81 | 89 |

When the heating time was 2 hours, the eutectic Na₂CO₃—NaCl carbonate-based flux was able to extract over 90% of the La, about 90% of the Nd and about 75% of the Ce present in the natural monazite. The lower recovery of Ce was again thought to be due to the formation of CeO₂ during the thermal treatment stage, which is insoluble in acid.

Only the yields of La, Ce and Nd were measured, as these were the major constituents of the natural monazite sample (i.e. see FIG. 2). It was noted that other rare earth elements including Pr, Sm, Eu, Gd, Lu also found in monazite (albeit at lower concentrations) tend to have similar yields to La and Nd. Therefore, it was expected that the eutectic Na₂CO₃—NaCl carbonate-based flux was also able to extract rare earth elements besides La, Ce and Nd from monazite.

These experiments showed that the eutectic Na₂CO₃—NaCl carbonate-based flux was suitable for recovering rare earth elements from phosphate minerals, such as monazite. It was noted that this was advantageous because the cost of sodium-based reagents can be significantly lower than the cost of potassium-based reagents. By employing a flux comprising only sodium-based reagents, the overall cost of the process may be lowered. However, the recovery of rare earths using the eutectic Na₂CO₃—NaCl flux indicated that a wide range of carbonate-based flux compositions could be used for this process.

### Example 7—Xenotime: Carbonate Ratio

In this set of experiments, samples of natural xenotime were separately mixed with the eutectic Na₂CO₃—K₂CO₃—KCl and the synthetic Oldoinyo Lengai carbonate-based fluxes and subjected to the experimental procedure afore-described. For both fluxes, the following mass ratios of flux to synthetic monazite were tested: 0.2:1, 2.5:1, 3.3:1, 5:1, 10:1, 20:1. The predetermined time was one hour. The composition of rare earth elements (FIG. 2) were known from previous analyses. The experimental procedure was also performed on a sample of only xenotime (that is, no flux) for comparison. When no flux was used, the predetermined time was 3 hours.

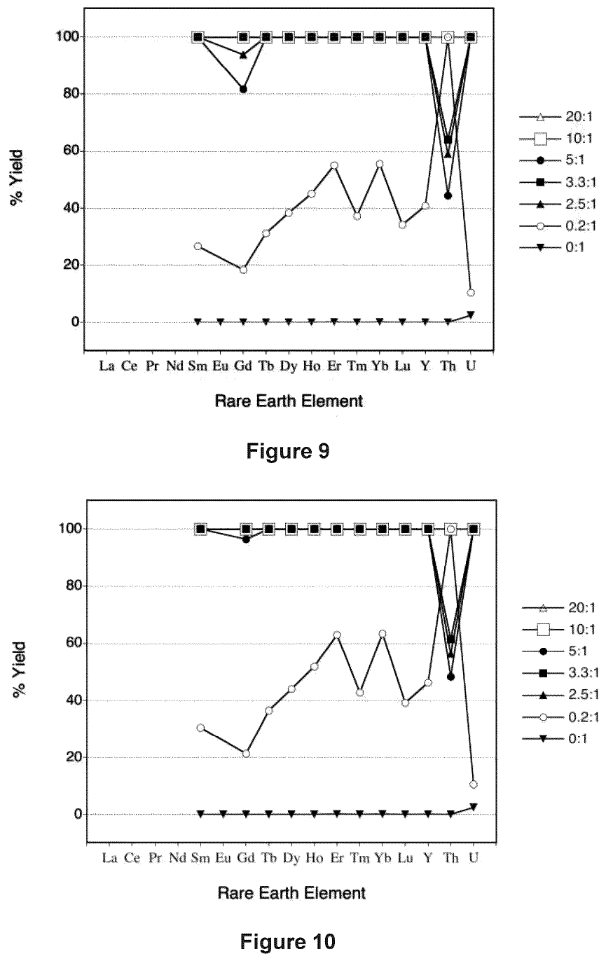

FIGS. 9 and 10 show the recoveries from xenotime for different ratios of flux to xenotime when the xenotime was mixed with the eutectic Na₂CO₃—K₂CO₃—KCl and synthetic Oldoinyo Lengai fluxes respectively. The recovery of rare earth elements from xenotime when no flux was used was <1%, which indicated that mixing the xenotime with a flux was necessary to recover the rare earth elements. The recovery of rare earth elements was nearly identical for all mass ratios of flux to xenotime of 2.5:1 and greater, resulting in the overlap of several datasets in each Figure.

When the xenotime was mixed with the eutectic Na₂CO₃—K₂CO₃—KCl flux (FIG. 9), nearly 100% recovery of nearly all the rare earth elements occurred, for mass ratios of flux to xenotime greater than 0.2:1.

The recovery of U and Th was also measured, as these elements are radioactive. For all flux to xenotime ratios above 0.2:1, substantially all the U was extracted from the xenotime. This meant that U was present in the solution comprising rare earth elements. In a commercial-scale process, the U will need to be removed (e.g. by precipitation) from the solution prior to the recovery of the rare earth elements.

For some ratios of flux to xenotime, the recovery of Th was below 100%. Specifically, for ratios of 5:1, 3.3:1 and 2.5:1, the Th recovery was between about 40% to about 60%. This meant that, depending on the operating conditions of the thermal treatment stage 30 (FIG. 1), the Th was either in the solution comprising rare earth elements 72 or the solid residue 74. Where the Th was in the solid residue 74, the residue could be disposed of as radioactive waste. On the other hand, where the Th was in the solution 72, it could be removed (e.g. by precipitation or electrolysis) from the solution prior to the recovery of the rare earth elements.

### Example 8—Recovery of Zirconium from Natural Zircon

In this experiment, samples of natural zircon were mixed with the eutectic Na₂CO₃—NaCl flux. The ratio of the mass of flux to the mass of mineral was 5:1. The combined material weighed 1.8 g. The mixture was held in the box furnace at a temperature of 850° C. for 18 hours. After 18 hours, the mixture was quenched by turning off the power to the furnace. It was noted that some of the experimental conditions, such as the predetermined temperature and time, had to be increased compared to those used for monazite and xenotime when the mineral was zircon. However, the inventor noted that the temperature of 850° C. and the predetermined time of 18 hours was not optimised.

It was observed that about 67% by weight of the mass of the mixture was lost during heating. Without wishing to be bound by theory, it was thought that this was due to decarbonation during heating, with the zircon reacting with the sodium carbonate and sodium chloride according to the following equation:

ZrSiO4+2Na₂CO₃+NaCl→Na₂ZrO₃+Na₂SiO₃+2CO₂+NaCl

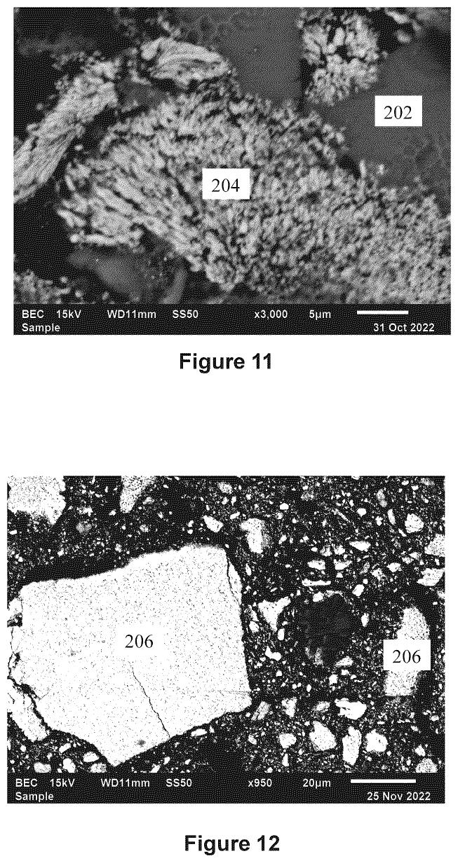

To determine the minerals present after the thermal treatment, a small portion of the quenched product was mounted in epoxy resin and imaged with a scanning electron microscope (SEM). Care was taken to avoid hydration of the sample during preparation. The composition of the phases present was determined by energy dispersive spectroscopy (EDS). A representative SEM image is shown in FIG. 11. The EDS analysis indicated the presence of a NaCl phase 202 and a Na₂ZrO₃ phase 204. This supported the idea that zircon can be converted into new Zr- and Si-compounds by heating in the flux.

The remainder of the quenched product was leached using 200 mL water in triplicate to ensure complete dissolution of residual Na₂CO₃ and NaCl. It was observed that Na₂CO₃, Na₂SiO₃ and NaCl were dissolved from the quenched product during the water wash.

Without wishing to be bound by theory, the inventor postulates that the Na₂ZrO₃ phase converted to ZrO(OH)₂ during washing of the quenched residue, according to the following reaction:

Na₂ZrO₃+H₂O→ZrO(OH)₂+Na₂O

The Na₂O then formed sodium hydroxide (NaOH) during the water wash and was therefore also dissolved from the quenched product.

To convert ZrO(OH)₂ to ZrO₂, the sample was calcined at 800° C. for 4 hours. A sample of the calcined solid was mounted in epoxy resin and examined by SEM and EDS. A representative SEM image is shown in FIG. 12. EDS analyses indicated that the calcined sample 206 was composed almost entirely (about 90% by weight) of ZrO₂.

Although the acid leaching step was not performed in this experiment, the acid leaching step of the process is well understood by those in the art. Since ZrO₂ is known to be soluble in certain acids, such as nitric acid, hydrochloric acid and sulphuric acid, it was expected that a significant proportion of the Zr would be extracted by an acid leach. Without wishing to be bound by theory, the inventor notes that, during acid leaching of the calcined solid, other components present such as Hf may also be extracted. The Zr can then be separated from these other components, e.g. Hf, in the resulting solution using standard methods.

This experiment showed that the process is suitable for recovering certain metals from silicate and/or oxide ores that comprise the certain metals. For example, the process is suitable for recovering zirconium from zircon.

The inventor also noted that reacting zircon with Na-compounds to produce Na₂ZrO₃ (which is then converted to ZrO(OH)₂ through washing) is a step in other metallurgical processing routes for zircon [I am wary of “traditional” since commercial processes i.e. traditional ones, are not always described in the literature and I have not done a comprehensive review of the field]. However, these routes typically employ sintering, which can require even higher operating temperatures. In contrast, this experiment showed that the process herein disclosed can enable the recovery of zirconium from zircon at lower temperatures, noting that the reaction conditions used in this Example are not optimised.

Variations and modifications may be made to the parts previously described without departing from the spirit or ambit of the disclosure. For example, these may be required when treating phosphate ores with different gangue minerals, or oxide or silicate ores, or different methods of uranium/thorium removal may be applied.

In the claims that follow and in the preceding description of the process, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the process.

The invention claimed is:

1.-34. (canceled)

35. A process for recovering one or more rare earth elements from a phosphate ore that comprises the one or more rare earth elements, the process comprising:
a) mixing the phosphate ore comprising the one or more rare earth elements with a carbonate-based flux, thereby forming a mixture;
b) subjecting the mixture to conditions comprising a temperature that causes the carbonate-based flux to melt, such that the one or more rare earth elements are released from the phosphate ore and form one or more rare earth element compounds; and
c) washing a resultant solid with water to substantially dissolve residual carbonate-based flux therefrom.

36. The process according to claim 35, wherein the conditions of b) comprise subjecting the mixture to the temperature that causes the carbonate-based flux to melt for a predetermined time, and whereby the phosphate ore comprising the one or more rare earth elements substantially dissolves in the molten carbonate-based flux.

37. The process according to claim 36, wherein the conditions of b) further comprise, after the predetermined time has elapsed, allowing the resultant molten mixture to solidify, thereby forming the one or more rare earth element compounds as the resultant solid.

38. The process according to claim 36, wherein the elevated temperature is in the range of about 500° C. to about 650° C.

39. The process according to claim 36, wherein the predetermined time is about 2 hours.

40. The process according to claim 35, wherein b) is conducted at ambient pressure.

41. The process according to claim 37, wherein the resultant one or more rare earth element compounds are separated from a residue of the solid.

42. The process according to claim 41, wherein the separation of the rare earth element compounds from the residue of the solid comprises crushing the solid comprising the one or more rare earth element compounds, thereby producing a crushed solid.

43. The process according to claim 42, wherein, in step c), the crushed solid is washed with water to substantially dissolve residual carbonate-based flux therefrom.

44. The process according to claim 43, wherein the wash water comprising the dissolved residual carbonate-based flux is separated and further treated to recover the carbonate-based flux, thereby producing a recovered carbonate-based flux, and wherein the process further comprises recycling at least a portion of the recovered carbonate-based flux to a).

45. The process according to claim 44, wherein the separation of the rare earth element compounds from the residue of the solid further comprises washing the resultant flux depleted solid with acid to substantially dissolve the one or more rare earth element compounds therefrom, thereby producing a solution comprising the one or more rare earth elements and the residue.

46. The process according to claim 45, wherein the acid has a concentration of about 1 M and wherein the acid comprises one or more of nitric acid, hydrochloric acid and/or sulfuric acid.

47. The process according to claim 45, further comprising separating the solution comprising the one or more rare earth elements from the residue, such as by filtration, and, optionally, further treating the solution comprising the one or more rare earth elements to thereby produce one or more rare earth element products.

48. The process according to claim 35, wherein the mixture of a) comprises a greater proportion by mass of the carbonate-based flux than the phosphate ore comprising the one or more rare earth elements.

49. The process according to claim 48, wherein the ratio of the carbonate-based flux to the phosphate ore by mass is at least 2:1.

50. The process according to claim 35, wherein the phosphate ore comprises at least one of the minerals monazite, xenotime or apatite.

51. The process according to claim 35, wherein the carbonate-based flux comprises sodium carbonate and potassium carbonate.

52. The process according to claim 51, wherein the carbonate-based flux further comprises chloride, in the form of at least one of sodium chloride or potassium chloride.

53. The process according to claim 52, wherein the carbonate-based flux comprises about 30% sodium carbonate, about 50% potassium carbonate and about 20% potassium chloride by weight.

54. The process according to claim 35, wherein the carbonate-based flux comprises sodium carbonate and sodium chloride.
